(19) United States
(12) Patent Application Publication
(10) Pub. No.: US 2005/0177935 A1
(43) Pub. Date: Aug. 18, 2005

(54) Jet assembly

(76) Inventor: Thanh Le, Richardson, TX (US)

Correspondence Address: FISH & RICHARDSON P.C., 1717 MAIN STREET, SUITE 500, DALLAS, TX, 75201, US

(21) Appl. No.: 10/958,930

(22) Filed: Oct. 4, 2004

(30) Foreign Application Priority Data
Feb. 27, 2004 (TW) 93105126
Apr. 23, 2004 (TW) 93111340

(51) Int. Cl. A61H 33/04

(52) U.S. Cl. 4/541.6

(57) ABSTRACT

A jet assembly includes a casing defining a flow path. The casing is adapted to be coupled to a basin, and an impeller is disposed in the flow path and adapted to generate a flow through the flow path. A motor includes a motor housing and a drive shaft coupled to the impeller. The motor housing is coupled to the casing.

The present application claims foreign priority benefits under 35 U.S.C. § 119 of Taiwanese patent application number 093105126 filed Feb. 27, 2004 and Taiwanese patent application number 093111340 filed in 2004.

### FIELD OF THE INVENTION

The present disclosure relates to water jets, and particularly to jet assemblies for use in a spa or tub.

### BACKGROUND OF THE INVENTION

With reference to FIG. 1, a prior art bath 1 is illustrated. In the prior art, a suction inlet motor 2, a plurality of tubes 3, an inlet 4, and a plurality of water outlets 5 are installed in the bath 1. In use, the motor 2 is actuated so that the suction inlet 4 will draw water into the motor 2 and force the water out of the motor through the tubes 3 to the outlets 5. The water is transferred to the outlets 5 through the tubes 3 so as to be propelled into the bath 1.

Upon use of the prior art system, the tubes 3, inlet 4 and outlets 5 are never fully purged. The constant presence of water in the system facilitates the growth of bacteria, mold, and algae. Additionally, the inlets 4 and outlets 5 are fixed so that they typically cannot be detached for cleaning. The tubes 3 also become difficult to clean, often requiring the use of bleach or cleaning agent added to the bath 1 and operation of the system for a period of time for cleaning. Failure to undertake the time-consuming and cumbersome process of forcing a cleaning solution through the prior art system, especially for systems used by many different people, can result in the spread of infectious bacteria and other disease, and results in a general unsanitary state of the bath

### SUMMARY OF THE INVENTION

A jet assembly includes a casing defining a flow path. The casing is adapted to be coupled to a basin, and an impeller is disposed in the flow path and adapted to generate a flow through the flow path. A motor includes a motor housing and a drive shaft coupled to the impeller. The motor housing is coupled to the casing.

Alternative implementations may also include an air intake to introduce air into the fluid flow. A mask may be disposed within the casing to direct the flow from the impeller. Additionally or alternatively, a shroud may be included to limit the movement of the impeller in the direction of the fluid flow.

A basin system includes a basin body and a plurality of jet assemblies coupled to the basin body. Each of the plurality of jet assemblies includes a motor coupled to an impeller. In another implementation, a method for removing a jet assembly from a basin includes removing a casing, impeller, and motor from the basin as a unit. Yet another implementation includes a method for cleaning a jet assembly in a basin. The method includes removing a cover from the casing of the jet assembly where the casing is coupled to the basin. The method also includes removing an impeller from the casing and cleaning at least one of a surface of the casing or a surface of the impeller.

### BRIEF DESCRIPTION OF THE DRAWINGS

FIG. 1 is a schematic view of a prior art bath system.

FIG. 2 is a perspective view of an illustrative jet assembly in accordance with the invention.

FIG. 3 is an exploded perspective view of the water jet assembly of FIG. 2.

FIG. 4 is a cross sectional view of the jet assembly of FIG. 2.

FIGS. 5 and 5A are a cross sectional view and a detail cross sectional view of a portion of the jet assembly of FIG. 2.

FIGS. 6 and 6A are a cross sectional view and a detail cross sectional view of another portion of the jet assembly of FIG. 2.

FIG. 7 is a cross sectional view of the water jet assembly of FIG. 2 that illustrates a mode of operation of a jet assembly.

FIG. 8 and 8A are a cross sectional view and a detail cross sectional view of the nozzle of the jet assembly of FIG. 2.

FIG. 9 is an illustrative bath system including a plurality of jet assemblies in accordance with the invention.

FIG. 10 is a partial view in cross section of a jet assembly including an air inlet.

FIG. 11 is a cross sectional view of an illustrative water jet assembly that includes a water sensor in accordance with the invention.

FIG. 12 is a schematic of an illustrative water sensor for use with a water jet assembly in accordance with the invention.

FIG. 13 is a cross sectional view of the water jet of FIG. 11 illustrating a water level that is insufficient to allow operation of the jet.

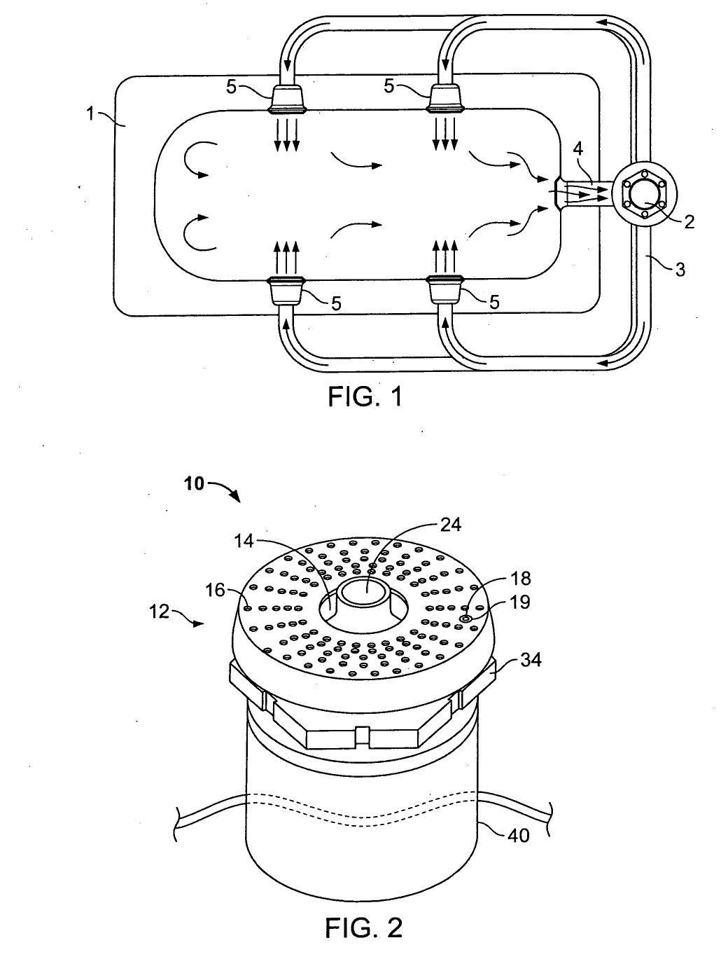

### DETAILED DESCRIPTION OF THE INVENTION

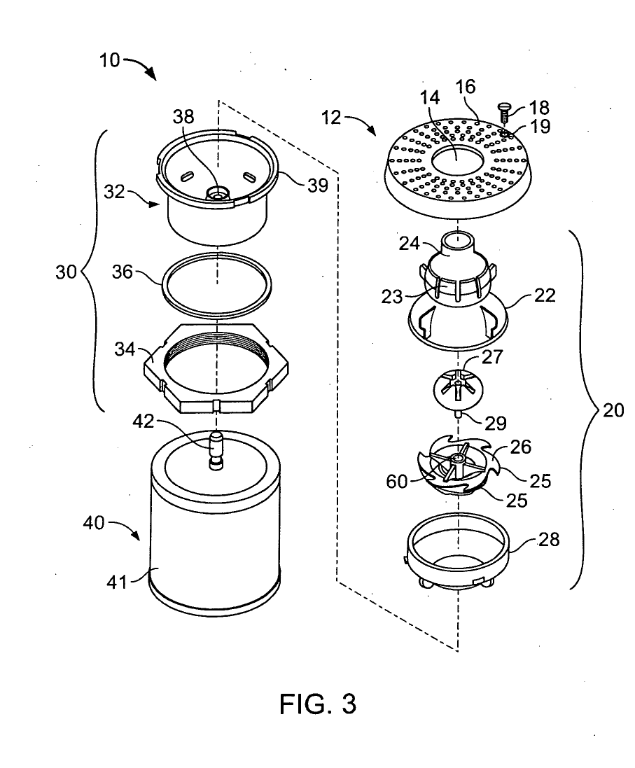

With reference to FIGS. 2 and 3, an illustrative water jet assembly 10 constructed in accordance with the invention includes a motor 40 with a housing 41, an intake cover 12 having a nozzle aperture 14 and one or more intake apertures 16, and a locking ring 34. A fastener 18 may also be included to secure the cover 12 to a casing 32. The motor 40 provides rotational energy via a drive shaft 42 through the casing 32 to a cycling unit 20. The intake apertures 16 may be sized such that debris such as dirt, foreign objects, hair, or other matter may not enter the casing 32 when the cover 12 is secured to the casing 32.

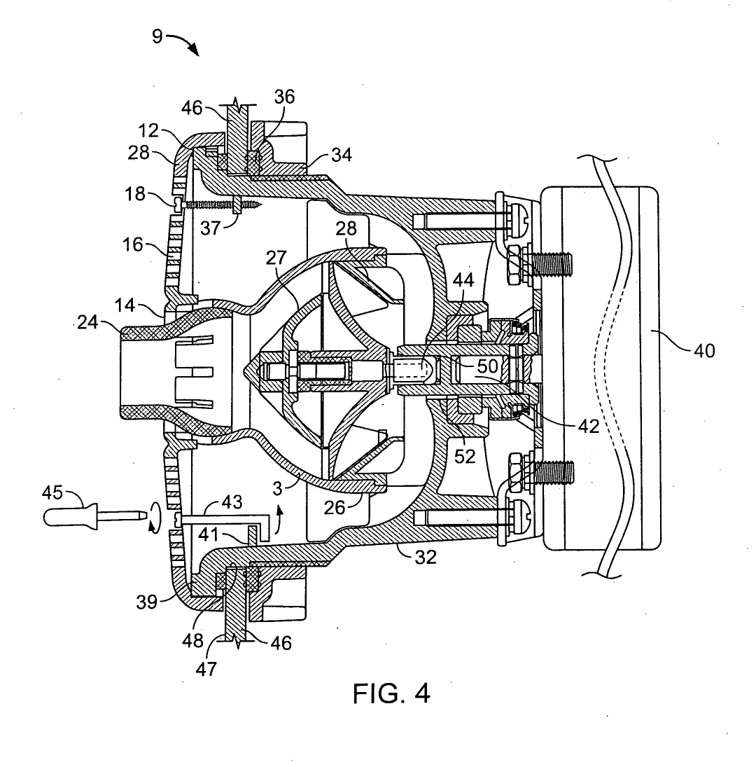

In the implementation shown, the cycling unit includes a mask 22, a nozzle 24 movably secured within flanges 23, an impeller 26, and an impeller seat 28. A casing assembly 30 may include the jet casing 32, a locking ring 34, and a sealing ring or O-ring 36. Additionally, the casing 32 may be coupled to the motor housing 41. As shown in FIG. 4, the jet casing 32 includes a flange 39 that may be sized such that the body of the casing 32 may be inserted from the interior of a tub or basin 46 through a jet aperture 48 and the flange 39 seats against an interior surface 47 proximate to the jet aperture 48 of the basin 46. Once the body of the casing 32 is inserted through the interior of the basin 46, the O-ring 36 and the locking ring 34 may be tightened against the exterior of the tub to hold the casing 32 in place to prevent leakage of fluids from within the basin 46 through the jet aperture 48. It should be understood that various components, such as the casing 32, intake cover 12, one or more components of the cycling unit 20, and one or more components of the casing assembly 30 may be manufactured from suitable materials, such as polymers, copolymers, plastics, nylons, olefins, polybenzothiazole composite, metals, or other suitable materials having sufficient properties for jet assembly components.

In the implementation shown in FIG. 4, the locking ring 34 is threaded to mate with threads on the exterior of the body of the casing 32. In alternative implementations, other configurations such as a J-latch may be used to secure the locking ring 34 to the casing 32 to hold the casing 32 in place.

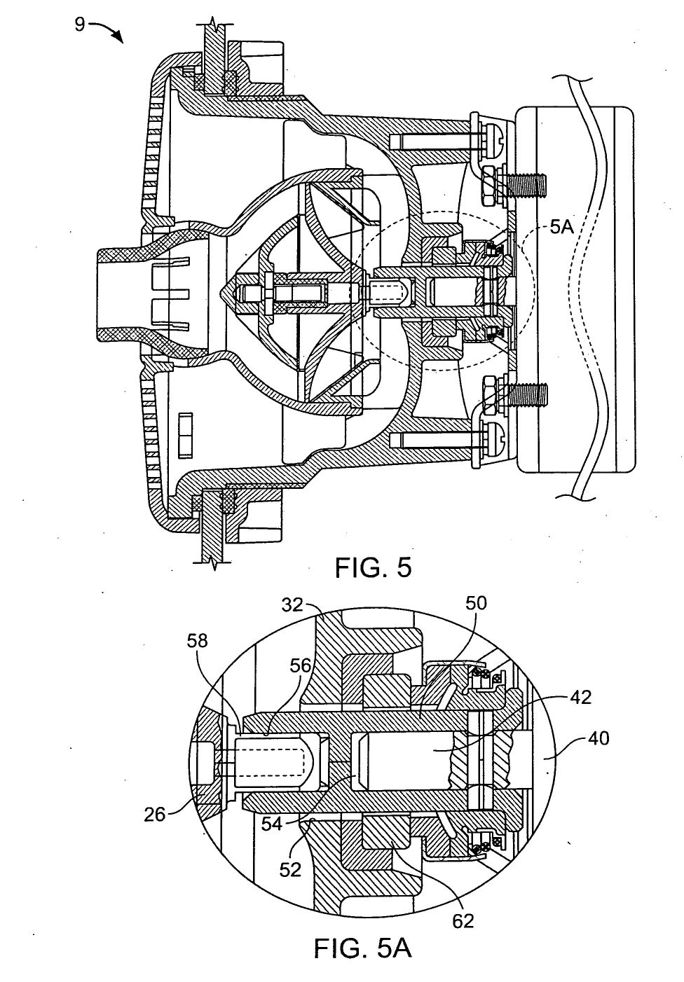

FIGS. 4 and 5 show a cross-sectional view of the water jet assembly 10. The motor 40 with drive shaft 42 is coupled to the jet casing 32 such that the drive shaft 42 operably engages a drive bushing 50. The drive bushing 50 may be positioned such that it protrudes through a drive aperture 52 in the casing 32. In the implementation shown in FIGS. 4 and 5, the drive bushing 50 has a drive receiver portion 54 adapted to receive the drive shaft 42 and an impeller receiver portion 56. Additionally, the impeller 26 includes an impeller shaft 58 adapted to be inserted into the impeller receiver portion 56 of the drive bushing 50.

FIG. 4 also shows fasteners 18 and 43, which may be used to secure the intake cover 12 to the casing 32. The fastener 18 may be a screw, bolt, or other suitable fastener that extends through the intake cover 12 and is secured into a screw tab 37. Alternatively or additionally, a J-latch 43 may be utilized such at the latch may be rotated into a secured position opposite the intake cover 12 proximate to a J-latch tab 41. The fasteners 18 and 43 may be hand manipulable. Alternatively, the fasteners 18 or 43 may be required to be manipulated by a tool, such as a screwdriver.

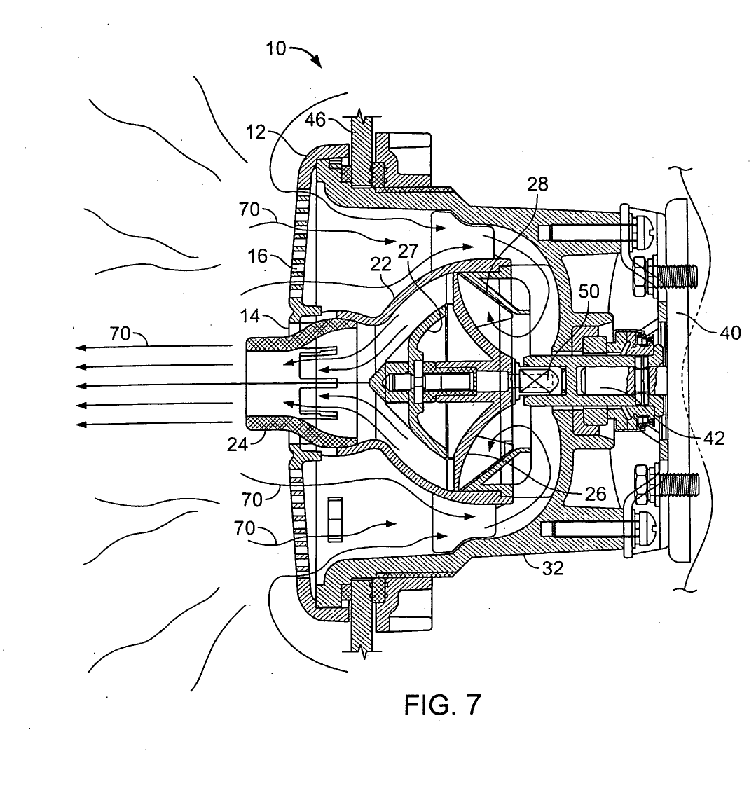

The impeller 26 includes fins 25 when the impeller 26 is rotated. The fins 25 draw fluid axially across the impeller 26 through the flowpath 70 (see FIG. 7).

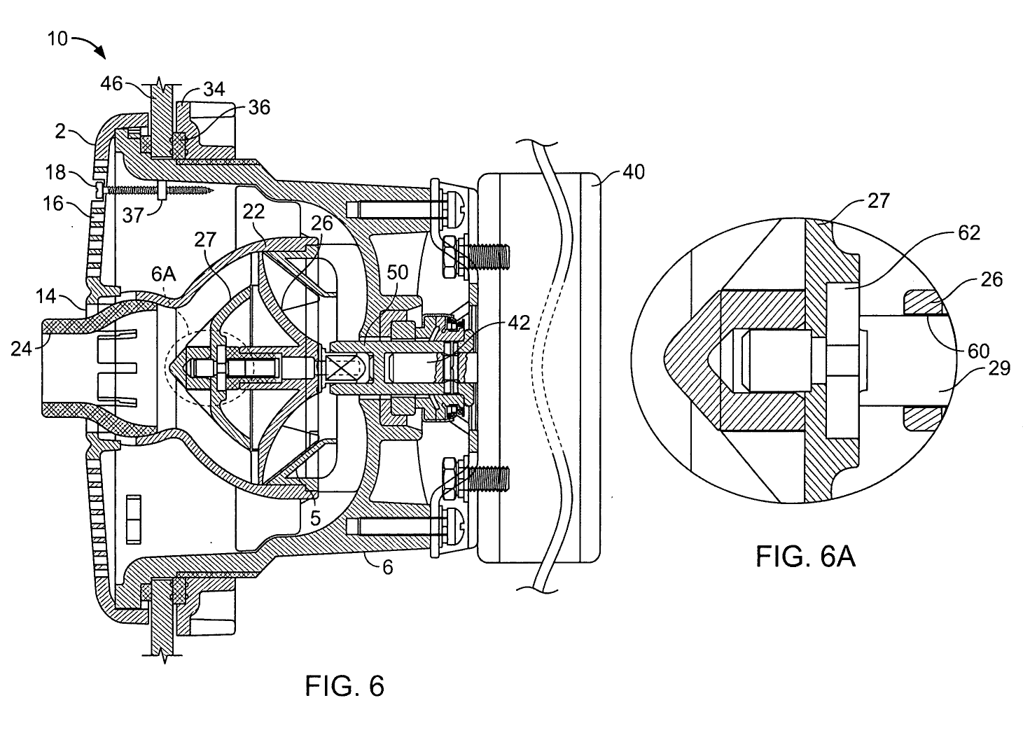

As shown in FIGS. 3 and 6, the impeller 26 may include a shroud receiver 60. The shroud receiver 60 is adapted to receive a shroud shaft 29. In operation, the shroud 27 and shroud shaft 29 operate to maintain the position of the impeller 26 in the cycling assembly 20 during the operation of the jet assembly 10. It should be understood that the shroud 27 is not necessary for the operation of the jet assembly 10. As shown in FIGS. 3 and 4, however, the impeller shroud 27 may be received in an interior of the mask 22 to prevent wear on the impeller 26 through excessive movement within the cycling assembly 20. Additionally, the impeller seat 28 may be coupled to the mask 22 to lock the impeller 26 into position within the cycling assembly 20. The impeller seat 28 may be coupled to the mask 22 by any suitable method, such as a J-latch, a rotational locking mechanism, or other suitable means. During operation of the water jet 10, the impeller shroud 27 may be static with respect to the rotation of the impeller 26. Accordingly, a bearing 62 may be installed at the shroud receiver 60 to bear against the impeller 26. The bearing 62 may be manufactured of any suitable wear-resistant material that allows rotation of the impeller 26 with respect to the shroud 27, such as nylon, graphite, metal, polyphenylene sulfide (PPS) composite or other suitable material to prevent wear of the shroud 27, the impeller 26, or both during operation of the water jet assembly 10.

FIG. 7 illustrates the operation of an implementation of the water jet 10. Upon activation of the motor 40, the drive shaft 42 rotates and imparts rotation to the drive bushing 50. The impeller shaft 58, inserted into the impeller receiver portion 56 of the drive bushing 50, in turn rotates the impeller 26. The rotation of the impeller 26 draws water, air, or other fluid or fluid mixture through the intake apertures 16. The impeller seat 28 may be positioned such that fluid flow, illustrated by directional arrows 70, may be drawn into the impeller 26 and thrust out of the nozzle 24. This thrust through the nozzle 24 provides a concentrated stream of fluid out of the jet assembly 10. The mask 22 and casing 32 define a fluid flow 70 through the jet assembly to that partitions fluid to drawn in at intake apertures 16 from fluid flow 70 thrust out of the impeller 26 and out nozzle 24. Partitioning fluid in this manner reduces any turbulence that could occur by fluid moving in opposite directions interacting.

In an alternate implementation the motor 40 may be reversed, so that the drive shaft 42 rotates in the opposite direction to that described above with respect to FIG. 7. Accordingly, operation of the jet assembly 10 in this manner would draw fluid through the nozzle 24 and force the fluid out of the jet assembly 10 through the intake apertures 16.

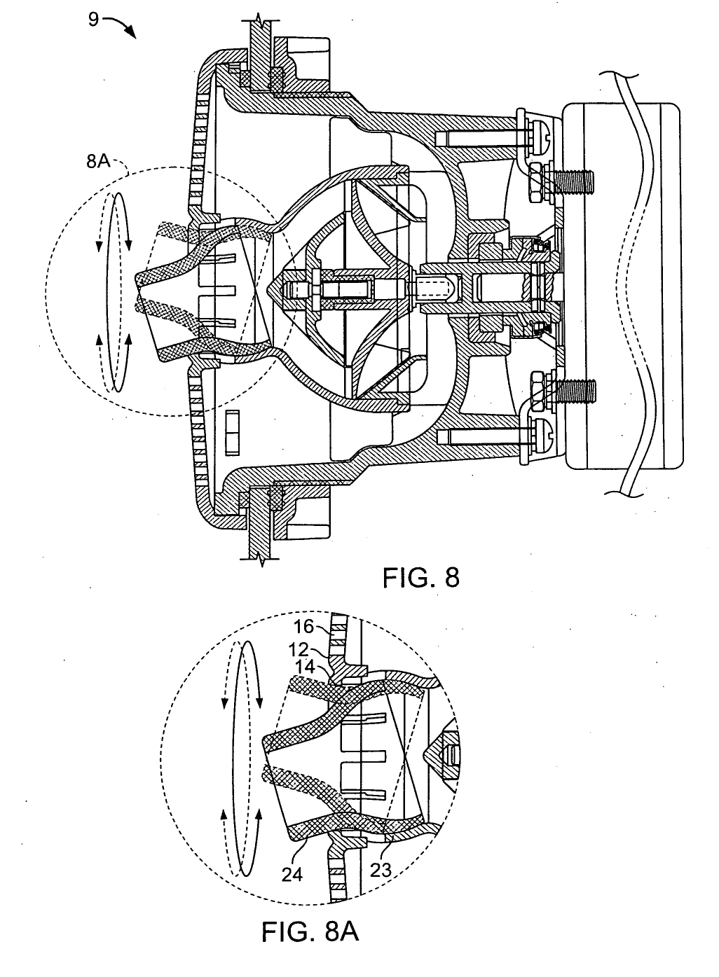

FIG. 8 illustrates an implementation of the jet assembly 10 in which the nozzle 24 is movably coupled to the mask 22 by flanges 23. In the implementation shown, the nozzle 24 includes a spherical portion adapted to fit into a substantially spherical cavity defined by the flanges 23 of the mask 22. The nozzle 24 may protrude through the nozzle aperture 14 such that the nozzle 24 may be manipulated into alternative positions by hand.

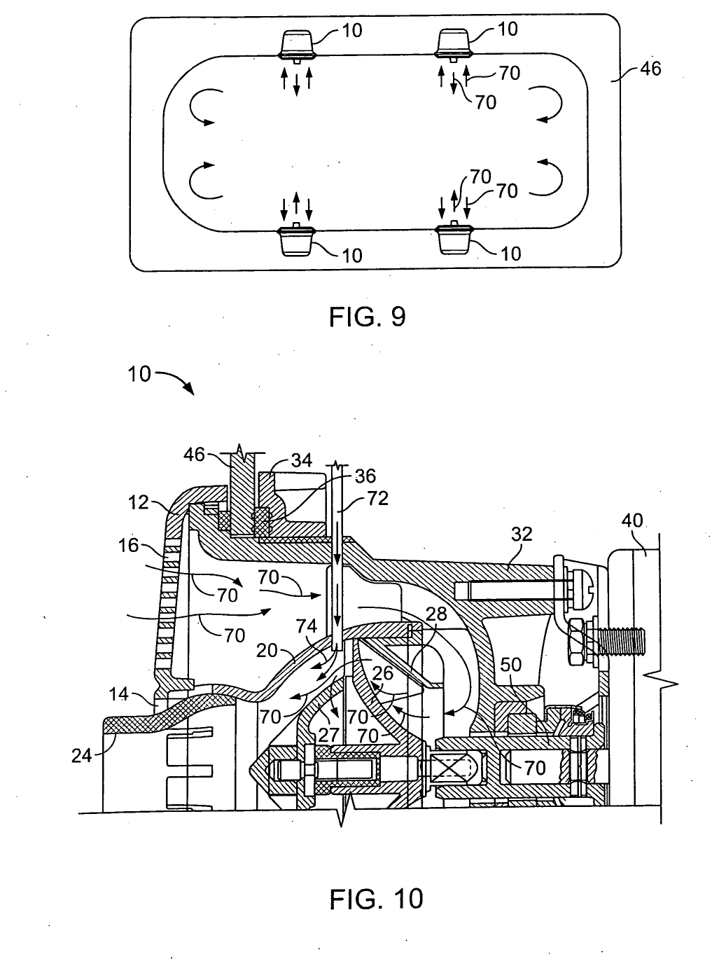

FIG. 9 illustrates an implementation that includes a plurality of jet assemblies 10 installed in a basin 46. It should be understood that any number of jet assemblies 10 might be installed in a basin 46 or similar container to provide fluid streams 70 within the basin. For example, in some situations a basin, for example a foot basin, may have only one jet assembly 10.

FIG. 10 illustrates an alternative implementation of a jet assembly 10 that includes an air intake 72. During operation of the jet assembly 10, the air intake 72 may provide an air stream 74 into the fluid 70, and the fluid 70 mixes with the air stream 74 to provide a fluid/air mixture 76 that is propelled through the nozzle 24. The air stream 74 may be forced through the air intake 72 by a compressor or other pressurized air source (not shown), or the air stream may be drawn through the air intake 72 through the creation of a vacuum by the velocity of the fluid 70 through the jet assembly 10.

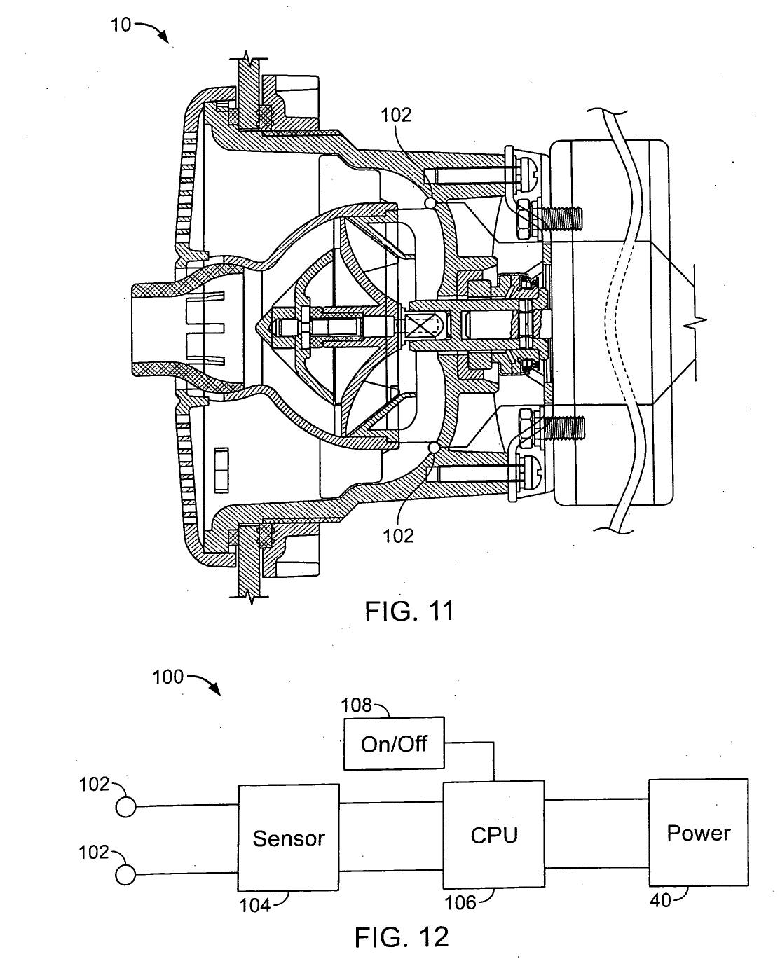

Referring to FIGS. 11, 12 and 13, another implementation includes an automatic shutoff system 100. The automatic shutoff system includes a plurality of sensors 102, a sensing element 104, a control element 106, and a switch 108. The sensors 102 may be connected to the sensing element 104 to detect the conductivity between the sensors 102.

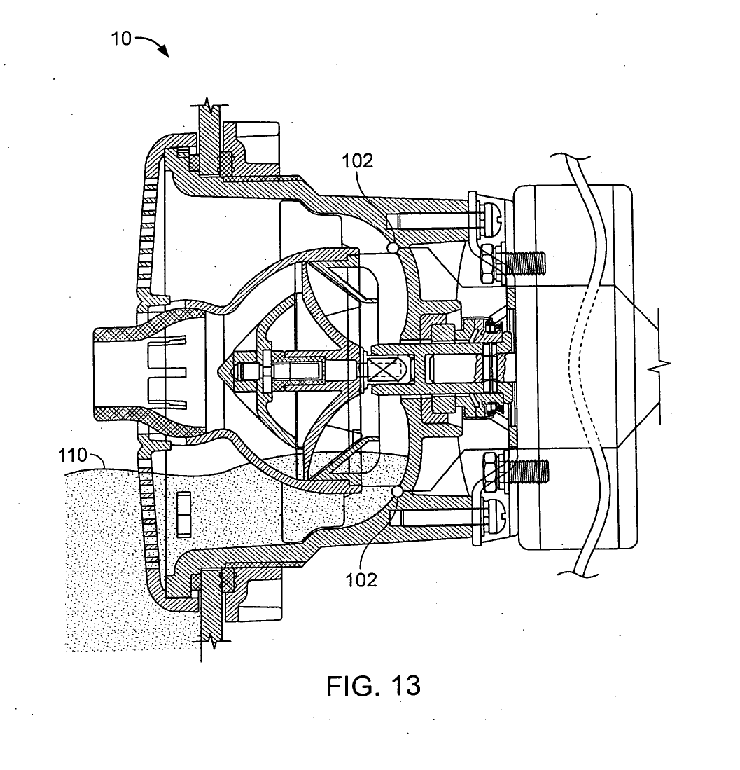

As best seen in FIG. 13, the jet assembly 10 may be positioned in a basin such that when a fluid level 110 within the jet assembly 10 is sufficiently high, the fluid completes the circuit between sensors 102, the sensing element 104 senses the completed circuit, and transmits a signal to the control element 106 that activates the switch 108. Conversely, if the fluid level 110 is too low, the circuit between sensors 102 is not complete, the sensing element 104 does not transmit a signal to the control element 106, and the control element 106 deactivates the switch 108. When the switch is deactivated, the motor 40 is shut off, so that the jet assembly 10 does not operate with insufficient fluid levels. Alternatively, the sensing element 104 may be operable to detect the resistivity of the fluid between the sensors 102, such that when the fluid level 110 is too low to contact all of the sensors 102, the sensing element 104 provides a signal to the control element 106, whereby the control element 106 deactivates the switch 108 to shut off power from the motor 40.

Though the subject matter contained above describes implementations of a jet assembly in detail, it should be understood that various modifications, substitutions, and/or additions might be made to various implementations without departing from the spirit and scope of the claims.

1. A jet assembly comprising:
a casing defining a flow path, the casing adapted to be coupled to a basin;
an impeller disposed in the flow path and adapted to generate a flow through the flow path; and
a motor including a motor housing and a drive shaft, the drive shaft coupled to the impeller and the motor housing coupled to the casing.

2. The jet assembly of claim 1, further comprising a mask adapted to fit within the casing and to direct the flow path from the impeller.

3. The jet assembly of claim 1, further comprising a nozzle coupled to the mask, the nozzle adapted to concentrate the flow out of the casing.

4. The jet assembly of claim 3, wherein the nozzle is removably coupled to the mask.

5. The jet assembly of claim 1, further comprising a cover removably coupled to the casing, the cover having a nozzle aperture disposed there through and a plurality of intake apertures disposed there through.

6. The jet assembly of claim 1, further comprising a locking ring adapted to secure the casing to the basin.

7. The jet assembly of claim 1, further comprising a drive bushing positioned through a drive aperture in the casing, the drive bushing including a drive receptacle and an impeller receptacle, the impeller including a shaft adapted to be insertably coupled to the impeller receptacle, the draft shaft adapted to be insertably coupled to the drive receptacle.

8. The jet assembly of claim 7, further comprising a bushing seal adapted to prevent fluid from exiting the casing through the drive aperture.

9. The jet assembly of claim 5, wherein the intake cover is secured to the casing by a fastener.

10. The jet assembly of claim 1, further comprising an impeller shroud adapted to prevent motion of the impeller along the flow path.

11. The jet assembly of claim 1, further comprising an automatic shutoof system, the automatic shutoof system including:
a plurality of sensors positioned within the casing, the plurality of sensors adapted to detect a resistance between the sensors, wherein the resistance between the plurality of sensors is determined by the amount of fluid in the casing, and wherein the sensors are operable to transmit a resistance signal indicating a fluid level;
a sensor control adapted to receive the resistance signal from the plurality of sensors and transmit the resistance signal; and
a control element operable to receive a signal from the sensor control and transmit a signal to the motor, wherein the signal from the control element is operable to disable the motor when the fluid level is insufficient to contact each of the plurality of sensors.

12. The jet assembly of claim 1, further comprising an air intake disposed through the casing, wherein the air intake is adapted to introduce air into the flow path.

13. A basin assembly, comprising:
a basin body; and
a plurality of jet assemblies coupled to the basin body, each of the plurality of jet assemblies having a motor coupled to an impeller.

14. The basin assembly of claim 13, each of the plurality of jet assemblies further comprising:
a casing defining a flow path, the casing adapted to be coupled to the basin body.

15. The basin assembly of claim 14, wherein each of the jet assemblies is removably coupled to the basin body.

16. The basin assembly of claim 15, wherein each of the casings includes a casing flange adapted to seat against an interior wall of the basin body proximate to an aperture in the basin body.

17. The basin assembly of claim 16, further comprising an locking ring adapted to secure the jet assembly to the basin body, the locking ring adapted to seat against an exterior wall of the basin body opposite the casing flange.

18. The basin assembly of claim 17, wherein removal of the locking ring from the exterior wall of the basin body allows the jet assembly to be removed from the basin body through the basin aperture.

19. A method for removing a jet assembly from a basin, the jet assembly including a casing, an impeller within the casing, and a motor, the method comprising removing the casing, impeller and motor from the basin as a unit.

20. The method of claim 19, the jet assembly further comprising a locking ring, the locking ring adapted to secure the jet assembly to the casing, the method further comprising removing the locking ring before removing the casing, impeller, and motor from the basin as a unit.

21. A method for cleaning a jet assembly in a basin, comprising:
removing a cover from a casing of a jet assembly, the casing coupled to a basin;
removing an impeller from the casing; and
cleaning at least one of a surface of the casing or a surface of the impeller.

22. The method of claim 21, wherein removing the cover from the casing includes loosening a fastener disposed through the cover and coupled to the casing.
